(19) United States
(12) Patent Application Publication
(10) Pub. No.: US 2023/0062376 A1
(43) Pub. Date: Mar. 2, 2023

(54) Adjustable Angle Razor

(71) Applicant: Eric James Holmstrom, Vancouver, WA (US)

(72) Inventor: Eric James Holmstrom, Vancouver, WA (US)

(21) Appl. No.: 17/412,243

(22) Filed: Aug. 25, 2021

(51) Int. Cl. B26B 21/22; B26B 21/52

(52) U.S. Cl. CPC B26B 21/225; B26B 21/521

(57) ABSTRACT

A safety razor comprising a handle and a blade unit having at least one blade, the handle has a handle axis, the blade unit is connected to the handle, the blade unit having at least one blade being substantially non-perpendicular to the handle axis. A safety razor comprising a handle and a blade unit having at least one blade, the handle has a handle axis, the blade unit is connected to the handle for a pivotal movement relative thereto about a perpendicular pivot axis substantially perpendicular to the handle axes, the blade unit with at least one blade can pivot into one or more substantially fixed axes substantially non-perpendicular to handle axis.

### CROSS REFERENCE TO RELATED APPLICATION

This application claims the benefit of U.S. Provisional Application No. 63/103,773, filed Aug. 25, 2020.

### FIELD OF THE INVENTION

The present invention relates to safety razors including an handle and a blade unit having at least one blade. The present invention relates to a safety razor having a blade unit connected to the handle, the blade unit having at least one blade being substantially non-perpendicular to the handle axis for cross cutting during shaving.

### BACKGROUND OF THE INVENTION

U.S. Pat. No. 8,205,343 clearly conveys that conventional safety razors have a blade unit connected to a handle for a pivotal movement about a single pivotal axis which is substantially parallel to the blade (i.e., the blade edge). The pivotal movement about the single axis provides some degree of conformance with the skin allowing the blade unit to easily follow the skin contours of a user during shaving. The pivot axis, which usually extends parallel to the cutting edges of the blades, can be defined by a pivot structure where the handle is connected to the blade unit. The blade unit pivots about an axis which is substantially perpendicular to the blade(s). Such safety razors have been successfully marketed for many years. However, the blade unit often disengages from the skin during shaving as it has limited ability to pivot about the single axis.

To address this problem, it was suggested that the blade unit can additionally pivot about another axis which is substantially perpendicular to the blade(s). For example, U.S. Pat. No. 8,205,343 discloses such a razor having a blade unit capable of an additional pivotal movement about a pivot axis substantially perpendicular to the blade(s). It is disclosed that the invention is directed to a safety razor which includes a handle and a blade unit having at least one blade. The blade unit is connected to the handle for a pivotal movement relative thereto about a perpendicular pivot axis substantially perpendicular to the handle axis and at least one blade for following the skin contours of a user during shaving. The blade unit having a rest position towards which the blade unit is biased by a return force when pivoted about the perpendicular pivot axis away from the rest position. These designs use a position biased movement transfer member with a resting position where the razor unit is always substantially perpendicular to the handle. The nature of using a force activated movement transfer member, some examples being a spring or an elastomeric component, is that less pressure translates to less movement, and more pressure translates to greater movement from the neutral bias position where the razor edge is substantially perpendicular to the handle axis. These designs require increased pressure of a blade against skin in order to increase shaving angle. Varied pressure of a blade against the skin in these design results in varied angles of blade edge contact with hair for reduced control and consistency. Increased pressure of the blade against skin translates into increased incidents of skin irritation, skin damage, and blade edge wear.

There is a need for a safety razor which is can enhance shaving comfort, can reduce skin irritation and damage, can extend blade edge performance life, can be produced by a simple manufacturing process, and is cost-effective to manufacture.

### SUMMARY OF THE INVENTION

Blades which are predominantly substantially perpendicular to the handle during the shaving process pulls hair, pulls skin, and increases skin irritation. While there are occasions and areas for shaving with the blades perpendicular to the handle and engaging hair at a perpendicular angle, most hair and skin are better addressed with a blade angle which is non-perpendicular. A cross-cutting of hair is a cleaner, smoother cut with less pull of the hair follicle and the skin, resulting in a close, more comfortable shave with less irritation. Furthermore, a non-perpendicular blade edge contact using a fixed angle generates a consistent angle of contact regardless of the pressure applied when shaving. Flexible pivot blade razors have a movement transfer member mechanism with a return bias to bring the razor unit into a perpendicular orientation relative to the handle and generate non-consistent angles of hair contact during the cutting of the hair and movement across the skin. With flexible pivot blade razors, increased force is required for increased non-perpendicular angle which can result in greater skin irritation.

The invention delivers non-perpendicular cross cutting shaving resulting in close shaving, increased consistent cutting, reduced irritation, and the ability to receive benefits independent of the pressure of the blades on the hair or skin. The non-perpendicular cross cutting shaving of this invention generates reduced blade vibration, reduced blade clogging, and results in longer-lasting (extended blade life) blade edges for higher quality ongoing shaving. Independent of the blade material composition, the shave process is enhanced. The invention reduces shaving friction. Those with sensitive skin also benefit from the invention. The invention reduces resistance when the hair is being cut.

### BRIEF DESCRIPTION OF THE DRAWINGS

While the specifications concludes with claims particularly pointing out and distinctly claiming the subject matter which is regarded as forming the present invention, it is believed that the invention will be better understood from the following description taken in conjunction with the accompanying drawings.

FIGS. 1A and 1B are a front and side perspective view of a generic safety razor:

FIGS. 2A and 2B and 2C include perpendicular and non-perpendicular reference angles relative to handle angle:

FIGS. 3A and 3B are front perspective views of safety razors which are embodiments of the present invention:

FIGS. 4A and 4B and 4C are front perspective views which explain adjustable function for one embodiment of the present safety razor invention:

FIGS. 5A and 5B and 5C and 5D are front perspective and exploded views which explain design conversion function using an adapter which is one embodiment of the present invention:

FIGS. 6A and 6B and 6C and 6D are front perspective and exploded views which explain design conversion function using an adapter which is one embodiment of the present invention:

FIGS. 7A and 7B and 7C are front and back perspective views which explain design conversion function using a twist or inversion which is one embodiment of the present invention:

FIG. 8 includes front perspective and side views which explain design conversion function using a twist or inversion which is one embodiment of the present invention:

FIGS. 9A and 9B and 9C and 9D and 9E and 9F are front and back perspective views which explain design conversion function using a twist or inversion which is one embodiment of the present invention:

FIGS. 10A and 10B and 10C are front perspective views which explain design conversion function using an integrated movement transfer mechanism which is one embodiment of the present invention:

FIG. 11 includes front perspectives which explain design conversion function and a locking mechanism which is one embodiment of the present invention:

FIG. 12 includes front perspectives which explain design conversion function and a locking mechanism which is one embodiment of the present invention:

### DETAILED DESCRIPTION OF THE INVENTION

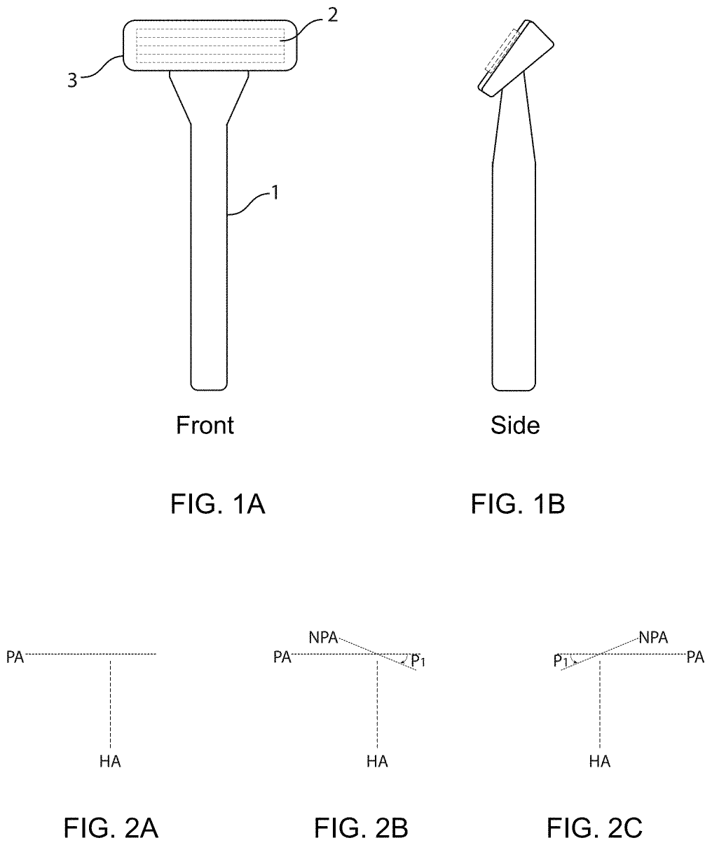

FIGS. 1A and 1B are a front and side perspective view of a generic safety razor. Handle 1 shown in FIG. 1A demonstrates a relative orientation perpendicular to both blade unit 3 and razor blade(s) 2 as seen from either a front view or back view.

FIGS. 2A and 2B and 2C include perpendicular and non-perpendicular reference angles relative to handle angle. It is these two primary relative axes from a front or back perspective which define references to perpendicular and non-perpendicular in the embodiments to follow. Handle angle HA, perpendicular angle PA, and non-perpendicular angle NPA are seen in FIGS. 2A and 2B and 2C. These angles represent front and back view perspectives where handle angle HA remains constant on the one axis while the perpendicular angle PA and the non-perpendicular angle NPA are refer to side to side orientation relative the handle angle HA.

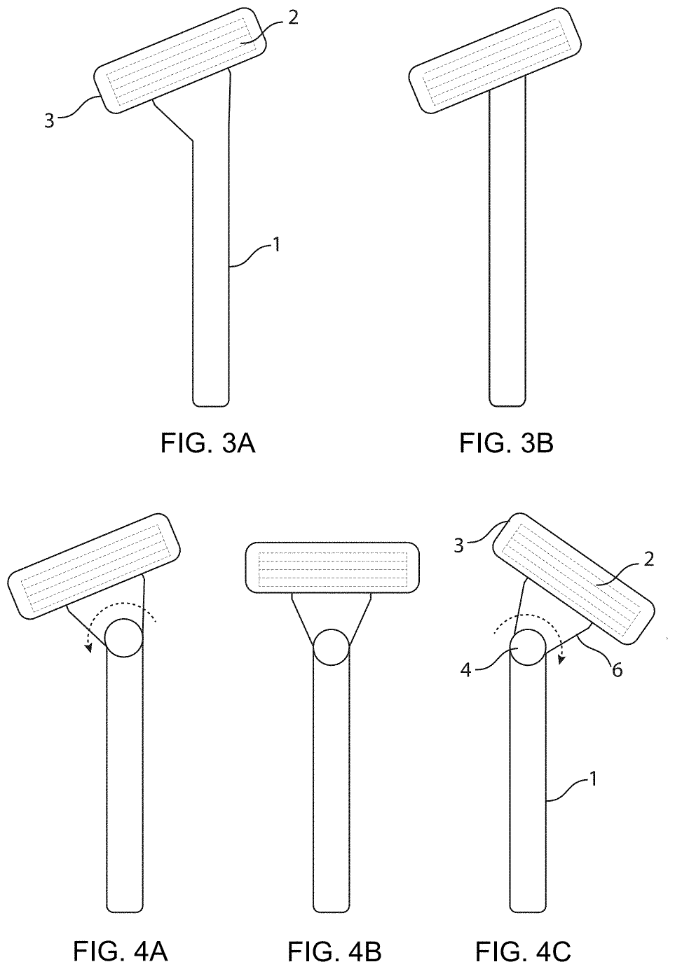

FIGS. 3A and 3B are front perspective views of safety razors which are embodiments of the present invention. In these two embodiments, the blade edge 2 is non-perpendicular to the handle axis. These designs are typical or disposable and replaceable cartridge razors where the blade unit 3 is substantially fixed to the handle unit and the blade unit 3 is not substantially adjustable to another angle orientation relative the handle angle HA seen in FIGS. 2A and 2B and 2C.

FIGS. 4A and 4B and 4C are front perspective views which explain adjustable function for one embodiment of the present safety razor invention. In this embodiment, blade unit 3 and connector 6 are able to pivot via mechanism 4 into multiple substantially non-moving substantially non-perpendicular positions as well as substantially non-moving per substantially perpendicular positions relative to handle angle HA to affect varied blade edge 2 angles for shaving.

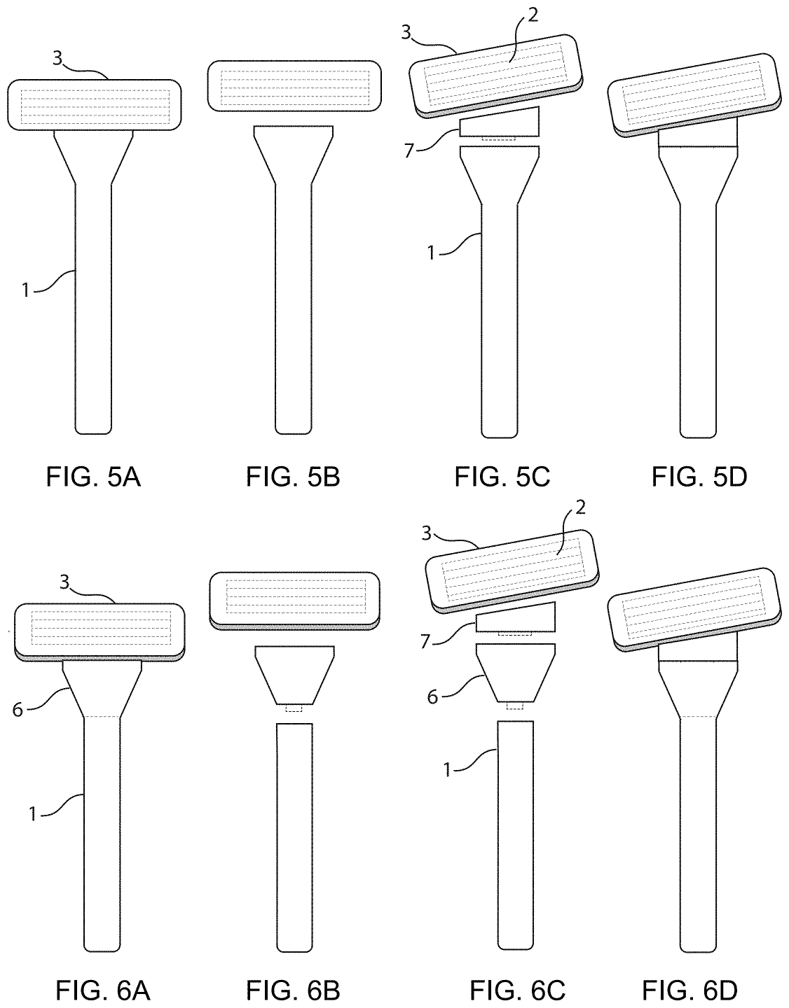

FIGS. 5A and 5B and 5C and 5D are front perspective and exploded views which explain design conversion function using an adapter which is one embodiment of the present invention. FIG. 5A shows a standard razor handle 1 and a standard replaceable blade unit 3 attached. FIG. 5B shows and exploded view of FIG. 5A where the two components are separated. FIG. 5C shows a further exploded view which includes an adapter 7 which connects to both razor handle 1 and blade unit 3 to result in a new angle for blade edge 2 relative to handle angle HA of handle 1.

FIGS. 6A and 6B and 6C and 6D are front perspective and exploded views which explain design conversion function using an adapter which is one embodiment of the present invention. As with FIG. 5 above, FIG. 6A shows a standard razor handle 1 and a standard replaceable blade unit 3 attached. Razor handle 1 is connected to blade unit 3 via a connector 6. FIG. 6B shows and exploded view of FIG. 6A where the two components are separated. FIG. 6C shows a further exploded view which includes an adapter 7 which connects to both connector 6 and blade unit 3 to result in a new angle for blade edge 2 relative to handle angle HA of handle 1.

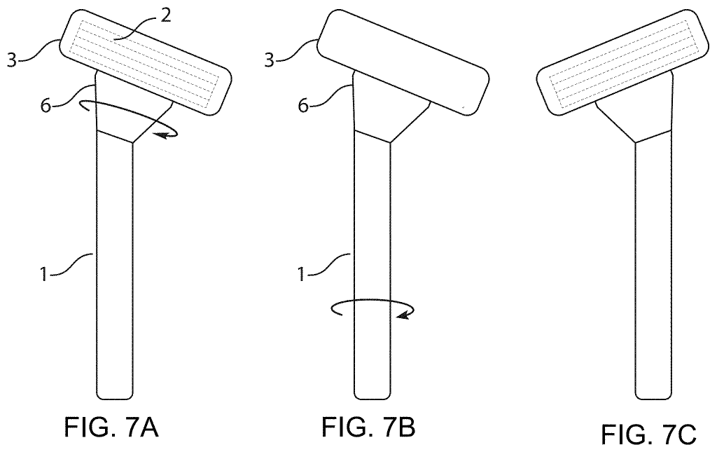

FIGS. 7A and 7B and 7C are front and back perspective views which explain design conversion function using a twist or inversion which is one embodiment of the present invention. In this embodiment, FIG. 7A depicts a twist of connector 6 which is connected to blade unit 3 of 180 degrees while holding handle 1 in place results in the view seen FIG. 7B which shows the back view of connector 6 and blade unit 3. FIG. 7C reflect turning the entire unit shown in FIG. 7B 180 degrees to reveal a front view where the blade edge 2 is set to a new angle relative to the handle angle HA and the blade edge 2 in FIG. 7A. The handle angle HA in both FIG. 7A and FIG. 7C are the same.

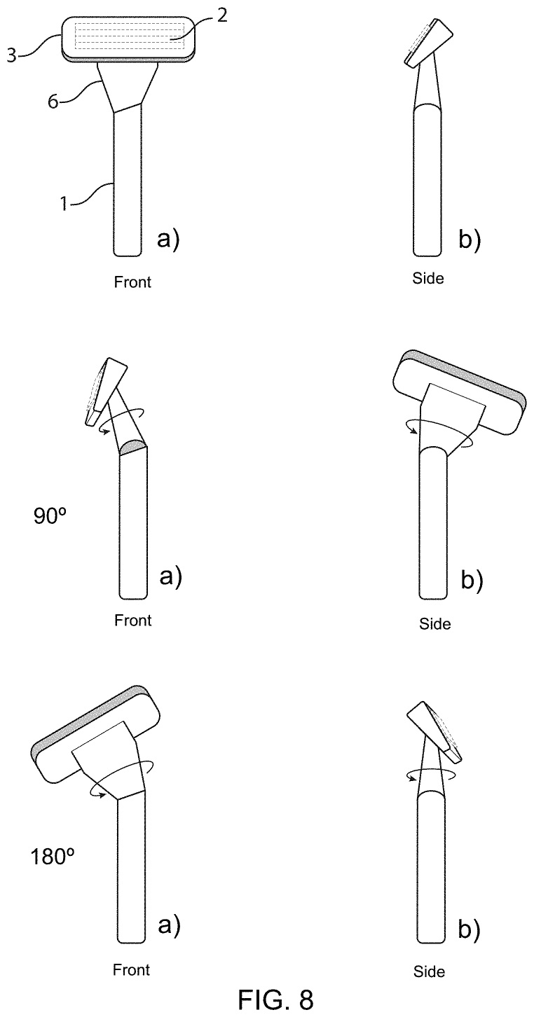

FIG. 8 includes front perspective and side views which explain design conversion function using a twist or inversion which is one embodiment of the present invention. In this embodiment, FIG. 8 depicts a twist of connector 6 which is connected to blade unit 3 of both 90 degrees and 180 degrees while holding handle 1 in place. This is a more detailed perspective of the embodiment seen in FIGS. 7A and 7B and 7C.

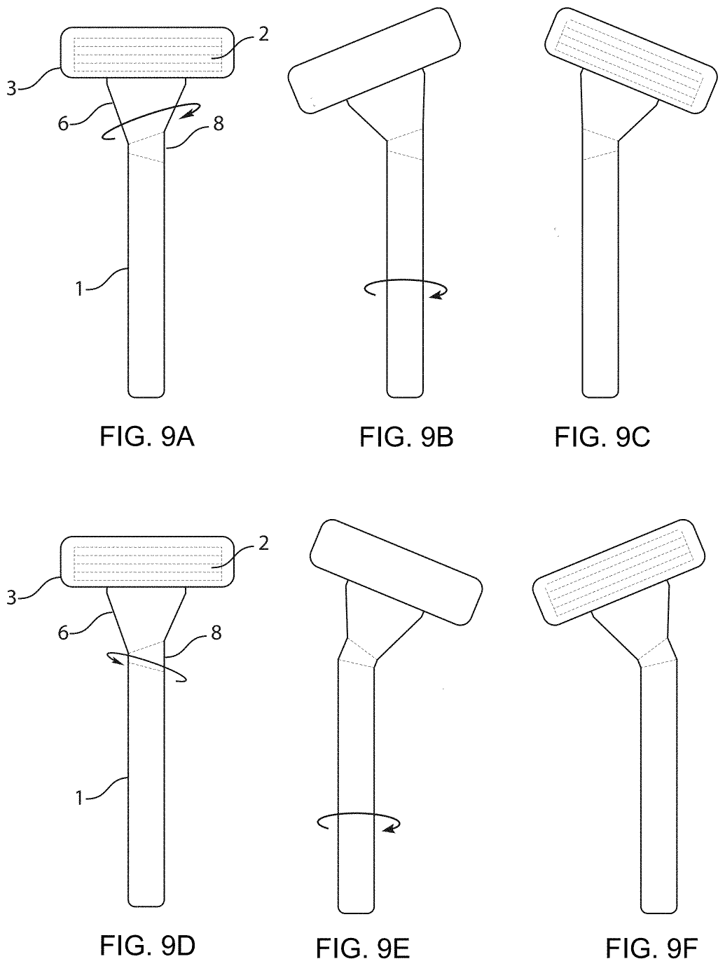

FIGS. 9A and 9B and 9C and 9D and 9E and 9F are front and back perspective views which explain design conversion function using a twist or inversion which is one embodiment of the present invention. Similar to the embodiment in FIGS. 7A and 7B and 7C and FIG. 8 except with this embodiment includes an additional connector 8. FIGS. 9A and 9B and 9C depict a sequence of movement by holding connector 8 and handle 1 while twisting connector 6 with blade unit 3 180 degrees to change the blade edge 2 angle from perpendicular angle PA to handle angle 1 to a non-perpendicular angle NPA to handle angle 1. FIGS. 9D and 9E and 9F depict a sequence of movement by holding handle 1 while twisting connector 8 with connector 6 with blade unit 3 180 degrees to change the blade edge 2 angle from perpendicular angle PA to handle angle 1 to a non-perpendicular angle NPA to handle angle 1.

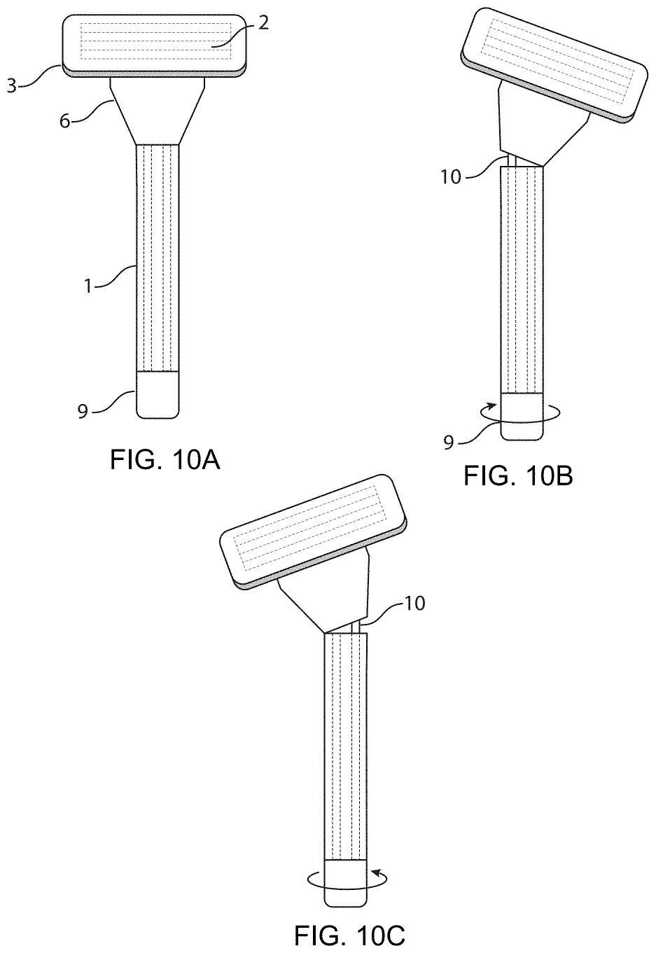

FIGS. 10A and 10B and 10C are front perspective views which explain design conversion function using an integrated movement transfer mechanism which is one embodiment of the present invention. By rotating activator knob 9 in one radial direction in the opposite direction, an internal mechanism of position transfer mechanism 10 which attached to connector 6 is engaged to raise or lower one side of connector 6 thereby effecting an angle change for blade edge 2. knob 9 can position connector 6 and edge 2 into substantially perpendicular and substantially non-perpendicular angles. While these position are substantially fixed settings, the connector 6 can be fixed or flexible and function from a controllable bias angle which is either perpendicular angle PA or non-perpendicular angle NPA relative the handle angle HA.

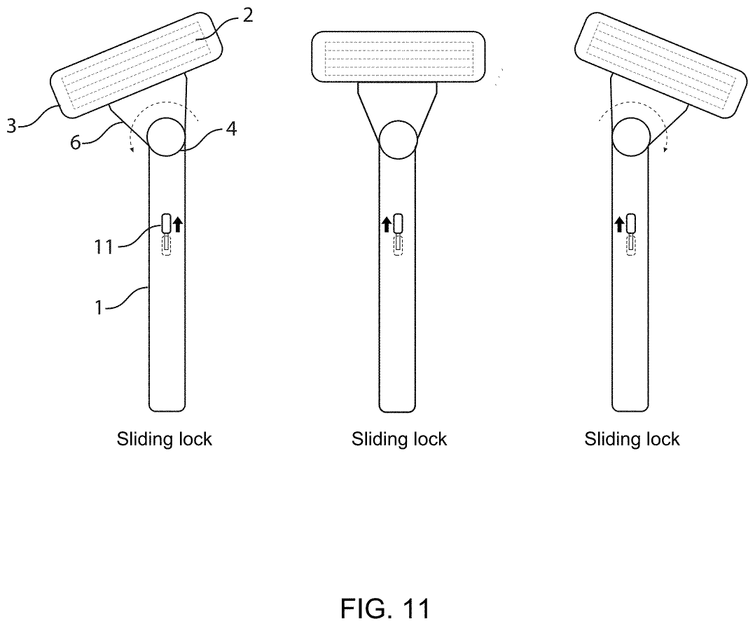

FIG. 11 includes front perspectives which explain design conversion function and a locking mechanism which is one embodiment of the present invention. FIG. 11 depicts connector 6 with blade unit 3 moveable about pivot 4 relative to handle angle HA of handle 1. A sliding lock 11 is used in this embodiment to secure the angle of connector 6 whether connector 6 is a fixed angle or flexible angle connector. Sliding lock 11 secures the bias angle which is either perpendicular angle PA or non-perpendicular angle NPA relative the handle angle HA.

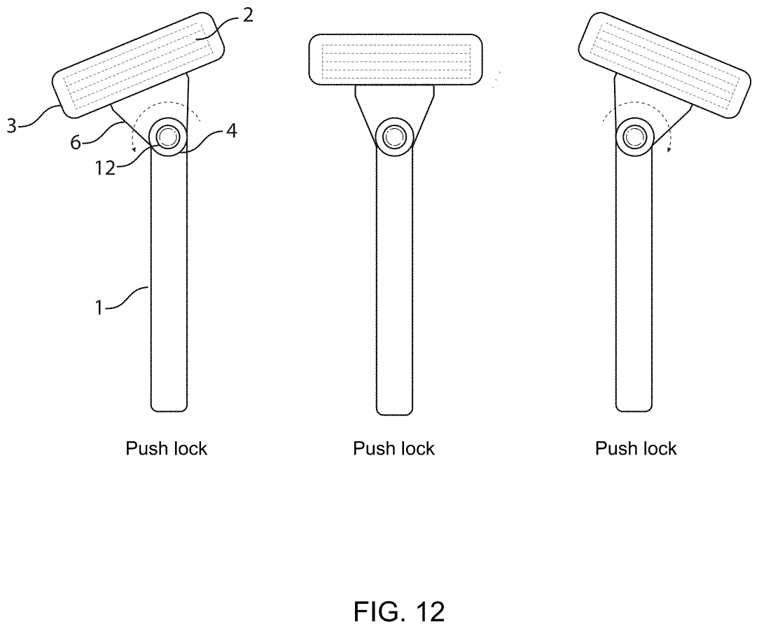

FIG. 12 includes front perspectives which explain design conversion function and a locking mechanism which is one embodiment of the present invention. FIG. 12 depicts connector 6 with blade unit 3 moveable about pivot 4 relative to handle angle HA of handle 1. A push lock 12 is used in this embodiment to secure the angle of connector 6 whether connector 6 is a fixed angle or flexible angle connector. Push lock 12 secures the bias angle which is either perpendicular angle PA or non-perpendicular angle NPA relative the handle angle HA.

What is claimed is:

1. A safety razor comprising a handle and a blade unit having at least one blade, the handle has a handle axis, the blade unit is connected to the handle, the blade unit having at least one blade being substantially non-perpendicular to the handle axis.

2. A safety razor comprising a handle and a blade unit having at least one blade, the handle has a handle axis, the blade unit is connected to the handle for a pivotal movement relative thereto about a perpendicular pivot axis substantially perpendicular to the handle axes, the blade unit with at least one blade can pivot into one or more substantially fixed axes substantially non-perpendicular to handle axis.

3. The safety razor according to claim 2, wherein the blade unit having at least one blade can pivot into one or more substantially fixed axes substantially non-perpendicular to handle axis and can pivot into a substantially fixed axis substantially perpendicular to handle axis.

4. The safety razor according to claim 2, wherein a position setting mechanism facilitates one or more angled positions relative to handle angle.

5. A safety razor comprising a handle and a blade unit having at least one blade, the handle having a handle axis, the blade unit is connected to the handle for a pivotal movement relative thereto about a perpendicular pivot axis substantially perpendicular to the handle axis, the blade unit with at least one blade can pivot into one or more substantially fixed axes neutral bias positions substantially non-perpendicular to handle axis, whereby the blade unit can pivot by force relative to the handle axis from the one or more substantially fixed axes neutral rest positions substantially non-perpendicular to handle axis. The blade unit having a neutral bias position towards which the blade unit is bias by a return force when pivoted about the pivot axis relative to the handle axis away from the neutral bias position substantially non-perpendicular to the handle axis, position bias movement transfer member with a neutral bias position where the razor unit is positioned substantially non-perpendicular to the handle.

6. The safety razor according to claim 5, wherein a handle and a blade unit having at least one blade, the handle having a handle axis, the blade unit is connected to the handle for a pivotal movement relative thereto about a perpendicular pivot axis substantially perpendicular to the handle axis, the blade unit with at least one blade can pivot into one or more substantially fixed axes neutral bias positions, including substantially perpendicular to handle axis.

7. The safety razor according to claim 5, wherein a position setting mechanism facilitates one or more angled positions relative to handle angle.
